(19) United States
(12) Patent Application Publication
(10) Pub. No.: US 2010/0157298 A1
(43) Pub. Date: Jun. 24, 2010

(54) POLARIMETRIC IMAGING APPARATUS

(75) Inventors: Daniel Robert Hayter, Worcestershire (GB); Greg Innes, Worcestershire (GB); David Leslie Jordan, Worcestershire (GB); John Andrew Haigh, Worcestershire (GB)

Correspondence Address: NIXON & VANDERHYE, PC, 901 NORTH GLEBE ROAD, 11TH FLOOR, ARLINGTON, VA, 22203, US

(73) Assignee: QINETIQ LIMITED, LONDON (GB)

(21) Appl. No.: 12/452,995

(22) PCT Filed: Jul. 21, 2008
(86) PCT No.: PCT/GB2008/002478

§ 371 Date: Feb. 18, 2010

(30) Foreign Application Priority Data
Aug. 1, 2007 (GB) 0714973.5

(51) Int. Cl. G01J 4/04; G02B 27/26

(52) U.S. Cl. 356/367; 359/465

(57) ABSTRACT

A polarimetric imaging apparatus (2) and method for distinguishing objects of interest within a scene, said apparatus comprising means for resolving electromagnetic radiation received from the scene having a first substantially circular polarisation state into a first image and for resolving electromagnetic radiation received from the scene having a substantially circular polarisation state of opposite handedness to that of the first circular polarisation state into a second image so as to identify differences there-between, and means for providing an output indicative of the difference there-between, wherein the resolving means is arranged in use to resolve said electromagnetic radiation into said first and second images successively.

The present invention relates to a polarimetric imaging apparatus and in particular to a polarimetric imaging apparatus sensitive to circularly polarised electromagnetic radiation. The invention relates specifically, but not exclusively, to a polarimetric imaging apparatus for use with binoculars. The present invention also relates to a method of distinguishing objects of interest within a scene using substantially circularly polarised light emanating there-from.

Polarimetric imagers are typically used to determine information about objects within a scene by making polarization of light within the scene more readily perceptible to a human viewer, either in real time, or in viewing recorded images. Example applications of polarimetric imagers include inspection of crops in order to locate disease, inspection of soil surfaces to locate areas of disturbance corresponding with buried objects, and discrimination between man-made objects and natural objects in cluttered environments. In the latter case, man-made objects within a naturally illuminated scene will tend to reflect light in a particular polarisation state, whereas natural objects tend to reflect light with a random polarisation state and hence will appear unpolarised.

By way of background to the present invention, known polarimetric imagers use a variety of configurations and techniques in order to determine information about the states and relative degrees of polarization of light emanating from objects within a scene. For example, U.S. Pat. No. 3,992,571, U.S. Pat. No. 5,264,916, U.S. Pat. No. 5,345,308 and U.S. Pat. No. 5,598,298 all describe polarimetric imagers having mechanically rotatable linear polarisers. U.S. Pat. No. 3,992,571, U.S. Pat. No. 5,264,916, GB 2,268,022A, U.S. Pat. No. 5,543,917 and U.S. RE37,752E (reissue of U.S. Pat. No. 5,557,324) describe polarimetric imagers employing multiple fixed linear polarisers. A third configuration comprising a liquid crystal rotator in combination with a fixed linear polariser is described in U.S. Pat. No. 5,404,225, U.S. Pat. No. 5,726,755, and U.S. RE37,752E.

Although the abovementioned polarimetric imagers are sensitive to linear and elliptical polarisation states, sensitivity decreases as the polarisation state approaches circular. Indeed, the abovementioned imagers are incapable of detecting all polarisation states; specifically they will not detect circular polarisation states. This inability to detect circularly polarised electromagnetic radiation has not hitherto been considered to be a shortcoming, especially for passive polarimetric imagers, since the amount of circularly polarised ambient light emanating from objects within a naturally illuminated scene has traditionally been thought to be negligible.

By way of example, U.S. Pat. No. 5,726,755 referenced above discusses a conventional polarimetric imaging technique and an imager in terms of manipulating and detecting a polarisation plane. Accordingly, it is inherent from the nomenclature used in U.S. Pat. No. 5,726,755 that the technique and imager described therein operate exclusively using linearly polarised light.

Furthermore, U.S. RE 37,752 specifically teaches that unpolarised light reflected from objects is almost always partially linearly polarised, thereby teaching away from using circularly polarised light for imaging objects within a scene.

In the interests of clarity, references in the prior art to elliptically polarised light merely indicate that the light has some substantially polarised component rather than being unpolarised. Such references to elliptically polarised light do not imply that the light is specifically circularly polarised.

Notwithstanding the foregoing, new research undertaken by the applicant has revealed that there is a significant amount of circularly polarised light generated from man-made objects within a naturally illuminated scene.

Indeed, this research has unexpectedly shown that imaging a naturally illuminated scene passively using a polarimetric imager sensitive to circularly polarised light has advantages over conventional methods which employ linear or elliptical polarisation states.

By way of example, the present polarimetric imaging apparatus is an improvement over conventional polarimetric imagers which modulate between linear polarisation states as the latter require a constant relative orientation between the scene, the source of illumination, and the imager for reliable and repeatable operation. In contrast, the present polarimetric imaging apparatus operates repeatably irrespective of the relative orientation between the scene, the source of illumination, and the imaging apparatus because the resolving means is not affected by the angle of orientation thereof about the optical axis.

The abovementioned advantage facilitates reliable imaging from moveable platforms, for example from moving vehicles. Furthermore, the present polarimetric imaging apparatus provides more consistent performance in situations where electromagnetic radiation illuminating a scene may have a changeable angle of incidence over time. A practical example of this is in the natural environment where ambient illumination varies as a function of the position of the sun throughout the day. Accordingly, the present imaging apparatus is less adversely affected by the angle of the sun or the time of day.

Hence, contrary to conventionally accepted wisdom, a polarimetric imager sensitive to circularly polarised light has been shown to provide a practical means for determining information about objects within a scene, and specifically for discriminating between man-made objects and natural objects within cluttered environments. Hence, in this respect the present invention overcomes a technical prejudice in the prior art.

Accordingly, it is an object of the invention to provide a polarimetric imaging apparatus which mitigates at least some of the disadvantages of the conventional devices described above. It is a further object of the invention to provide an improved imaging apparatus optimally sensitive to substantially circularly polarised electromagnetic radiation and to a method of imaging a scene using substantially circularly polarised electromagnetic radiation emanating there-from.

According to a first aspect of the present invention, there is now proposed a polarimetric imaging apparatus for distinguishing objects of interest within a scene, said apparatus comprising means for resolving electromagnetic radiation received from the scene having a first substantially circular polarisation state into a first image and for resolving electromagnetic radiation received from the scene having a second substantially circular polarisation state of opposite handedness to that of the first circular polarisation state into a second image, and means for providing an output indicative of the difference there-between, wherein the resolving means is arranged in use to resolve said electromagnetic radiation into said first and second images successively.

The electromagnetic radiation having the first substantially circular polarisation state may comprise left circular polarised electromagnetic radiation, and the electromagnetic radiation of opposite handedness may comprise right circular polarised electromagnetic radiation.

Preferably, the polarimetric imaging apparatus further comprises means for comparing the first and second images so as to identify differences there-between.

The present polarimetric imaging apparatus is an improvement over conventional polarimetric imagers which modulate between linear polarisation states as the latter require a constant relative orientation between the scene, the source of illumination, and the imager for reliable and repeatable operation. In contrast, the present polarimetric imaging apparatus operates repeatably irrespective of the rotational orientation between the scene and the imaging apparatus because the resolving means is not affected by the angle of orientation thereof about the optical axis. In addition, the present polarimetric imaging apparatus operates more reliably irrespective of the relative geometry of the scene, source of illumination and imaging apparatus.

The abovementioned advantage facilitates reliable imaging from moveable platforms, for example from moving vehicles. Furthermore, the present polarimetric imaging apparatus provides more consistent performance in situations where electromagnetic radiation illuminating a scene may have a changeable angle of incidence over time. A practical example of this is in the natural environment where ambient illumination varies as a function of the position of the sun throughout the day. Hence, the present imaging apparatus is less adversely affected by the angle of the sun or the time of day.

Preferably, the polarimetric imaging apparatus is adapted in use to passively distinguish objects of interest within the scene using ambient electromagnetic radiation received there-from.

Without limitation, differences between the first and second images may be identified by alternately displaying said first and second images. If the first and second images are repeatedly displayed in this manner any differences there-between will appear to scintillate or flash and therefore will become readily apparent to an observer. Advantageously, the frequency with which the first and second images are alternately displayed may be chosen such that any differences between said images are optimally conspicuous to the human eye.

Conveniently, the resolving means comprises a circular analyser arranged to resolve the received electromagnetic radiation into said first and second images.

Advantageously, the circular analyser comprises a linear polariser arranged in optical communication with a variable retarder configured to receive electromagnetic radiation from the scene. For the avoidance of doubt the linear polariser is arranged after the variable retarder in the optical path of the polarimetric imaging apparatus.

In the interests of clarity, the linear polariser transmits electromagnetic radiation unhindered in one orientation only which will be referred to herein as the transmission axis. As will be readily apparent to the skilled person, the intensity of electromagnetic radiation emerging from the polariser is reduced as a function of the cosine of the angle between the azimuth of the electromagnetic radiation and the orientation of the transmission axis of the polariser (Malus' Law wherein lₒᵤₜ=lᵢₙ cos² θ). In other words, only electromagnetic radiation having an optical field parallel to the transmission axis of the linear polariser will pass there-through essentially unaffected. Electromagnetic radiation having an optical field orthogonal to the transmission axis of the linear polariser will be completely blocked.

Preferably, the variable retarder is adapted in a first configuration to convert electromagnetic radiation having the first substantially circular polarisation state to a first linear polarisation state parallel to the transmission axis of the linear polariser. Radiation having the second circular polarisation state is converted to linearly polarised radiation which is orthogonal to the transmission axis of the linear polariser and hence will be blocked by the linear polariser.

In a preferred embodiment, the variable retarder is arranged in the first configuration to have a retardance of substantially 90 degrees. For example, the variable retarder may comprise a quarter-wave plate in said first configuration.

Even more preferably, the variable retarder is adapted in a second configuration to convert electromagnetic radiation having the second substantially circular polarisation state to the first linear polarisation state parallel to the transmission axis of the linear polariser. In this second configuration, radiation having the first circular polarisation state will be converted to linearly polarised radiation orthogonal to the transmission axis of the linear polariser and hence will be blocked by the resolving means.

In a preferred embodiment, the variable retarder is arranged in the second configuration to have a retardance of substantially 270 degrees. For example, the variable retarder may comprise a three-quarter-wave plate in said second configuration.

Thus, in operation, the present resolving means substantially transmits the first image there-through when the variable retarder is arranged in the first configuration. When the variable retarder is arranged in the second configuration, the variable retarder and the linear polariser cooperate to substantially transmit the second image there-through.

Preferably, the variable retarder is adapted in use to switch quickly between the first and second configurations such that any differences between the first and second images are optimally conspicuous to the human eye.

Advantageously, the variable retarder comprises a liquid crystal variable retarder (LCVR).

In a preferred embodiment, the variable retarder comprises a liquid crystal variable retarder in optical communication with a fixed retarder. In this embodiment, the fixed retarder may have a retardance of substantially 90 degrees and the liquid crystal variable retarder may have a retardance variable between zero degrees and 180 degrees. This configuration is beneficial in that the liquid crystal variable retarder need only exhibit a maximum retardance of 180 degrees rather than 270 degrees. For the avoidance of doubt, the retardance range of the variable liquid crystal retarder is 180 irrespective of whether a fixed retarder is employed or not.

In another preferred embodiment, the variable retarder comprises a chromatic variable retarder. In use, the chromatic variable retarder imparts a false hue to objects of interest within the scene since the amount of retardation created by the chromatic variable retarder varies as a function of the wavelength of the received electromagnetic radiation. This effect enables objects of interest to be readily distinguished within a spatial image of the scene. Varying both the hue and intensity of objects of interest ensures said objects are optimally conspicuous to the eye since human peripheral vision is particularly sensitive to intensity variations (flashing) whereas human direct vision is particularly sensitive to variations in hue (colouration).

In a preferred embodiment, the polarimetric imaging apparatus further comprises a sensor arranged to sense the first and second images transmitted through the circular analyser.

Where the polarimetric imaging apparatus comprises means for comparing the first and second images, said comparing means may preferably comprise a processor adapted in use to determine the difference between successive outputs from the sensor to provide said output indicative of the difference between the first and second images.

Advantageously, the successive outputs from the sensor and the output indicative of the difference between the first and second images comprise spatial images of at least part of the scene.

Conveniently, the processor is adapted in use to determine differences in image intensity between the successive outputs of the sensor and to denote objects of interest within the scene corresponding with said intensity differences. For example, the differences in image intensities may be determined by performing a pixel-wise comparison of identical spatial regions of the first and second images.

Preferably, the output means comprises a display adapted to display the output indicative of the difference between the first and second images.

In a preferred embodiment, the display comprises a spatial light modulator arranged in optical communication with the scene. The spatial light modulator may be arranged in optical communication with the scene via the circular analyser.

In a preferred embodiment, the polarimetric imaging apparatus further comprises a beam splitter arranged in optical communication with the first circular analyser. Preferably, the beam splitter comprises a polarising beam splitter in which case the linear polariser may be comprised of said polarising beam splitter.

Where the polarimetric imaging apparatus comprises a beam splitter, said beam splitter may be configured to receive electromagnetic radiation from the variable retarder and to separate said received electromagnetic radiation along two optical paths, the first optical path leading to the sensor and the second optical path leading to the spatial light modulator. This configuration is beneficial where the polarimetric imaging apparatus includes a spatial light modulator since it enables the output indicative of the difference between the first and second images displayed on the spatial light modulator to be superimposed on the scene.

During use, objects of interest are preferably distinguished within an image of the scene by varying at least one of hue, saturation and intensity of spatial regions within said image corresponding with said objects of interest.

Advantageously, the polarimetric imaging apparatus further comprises means for focusing electromagnetic radiation received from the scene onto the sensor, first passing through the circular analyser. For example, the focusing means may comprise a lens, a zoom lens, a telescope, etc.

Advantageously, the polarimetric imaging apparatus further comprises a source of substantially polarised electromagnetic radiation for actively illuminating the scene therewith. The source of substantially polarised electromagnetic radiation may comprise a source of substantially circularly polarised electromagnetic radiation for actively illuminating the scene therewith. Illuminating the scene with substantially circularly polarised electromagnetic radiation enables objects of interest to be distinguished within the scene with maximum contrast to their natural surroundings.

According to a second aspect of the present invention, there are now proposed binoculars comprising at least one polarimetric imaging apparatus according to the first aspect of the invention arranged in an optical path of said binoculars.

Preferably the binoculars have first and second optical paths there through and comprise a first polarimetric imaging apparatus according to the first aspect of the invention arranged in the first optical path thereof and a second polarimetric imaging apparatus according to the first aspect of the invention arranged in the second optical path thereof.

In a preferred embodiment, the first and second polarimetric imaging apparatuses each have a fast axis associated therewith, and wherein the fast axis of the first polarimetric imaging apparatus is orientated with respect to the fast axis of the second polarimetric imaging apparatus at an angle other than substantially zero degrees, 45 degrees, and 90 degrees.

In a preferred embodiment, the fast axis of the first polarimetric imaging apparatus is orientated at an angle of one of substantially 22.5 and 67.5 degrees to the fast axis of the second polarimetric imaging apparatus.

In another preferred embodiment, the fast axis of one of the first and second polarimetric imaging apparatuses is arranged at an angle of substantially 22.5 degrees to a plane passing through the first and second optical paths. In use, the binoculars will typically be held such that the first and second optical paths lie in a substantially horizontal plane.

According to a third aspect of the present invention, there is now proposed a method of distinguishing objects of interest within a scene comprising the steps of:
(i) receiving electromagnetic radiation from the scene,
(ii) resolving electromagnetic radiation received from the scene having a first substantially circular polarisation state into a first image,
(iii) resolving electromagnetic radiation received from the scene having a substantially circular polarisation state of opposite handedness to that of the first circular polarisation state into a second image,
(iv) providing an output indicative of the difference between the first and second images,
   wherein the steps of resolving the electromagnetic radiation received from the scene into said first and second images are performed successively.

In a preferred embodiment, the method comprises the step of comparing the first and second images so as to identify differences there-between.

Preferably, the step of comparing the first and second images so as to identify differences there-between is performed prior to step of providing the output indicative of the difference between the first and second images.

Advantageously, the method comprises passively distinguishing objects of interest within the scene using ambient electromagnetic radiation received there-from. For example, objects of interest within the scene may be distinguished passively using ambient electromagnetic radiation reflected from objects within the scene.

In a preferred embodiment, the step of resolving the electromagnetic radiation received from the scene having a first substantially circular polarisation state comprises converting said first substantially circular polarisation state into electromagnetic radiation having a first linear polarisation state. Said conversion may be performed by passing the electromagnetic radiation received from the scene through a variable retarder having a retardance of substantially 90 degrees in a first configuration; for example by passing through a variable retarder comprising a quarter-wave plate in said first configuration.

In another preferred embodiment, the step of resolving the electromagnetic radiation received from the scene having a second substantially circular polarisation state comprises converting said second substantially circular polarisation state into electromagnetic radiation having the first linear polarisation state. Said conversion may be performed by passing the electromagnetic radiation received from the scene through a variable retarder having a retardance of substantially 270 degrees in a second configuration; for example by passing through a variable retarder comprising a three-quarter-wave plate in said second configuration.

Preferably, the first and second images and the output indicative of differences there-between comprise spatial images of at least part of the scene and the step of comparing the first and second images comprises determining differences in image intensity there-between and denoting objects of interest within the scene corresponding with said intensity differences.

Advantageously, the method comprises the step of distinguishing objects of interest within the scene by varying at least one of hue, saturation and intensity of spatial regions within said output corresponding with said objects of interest.

Preferably, the method comprises the additional step of actively illuminating the scene with substantially polarised electromagnetic radiation. Even more preferably, the method comprising the step of actively illuminating the scene with substantially circularly polarised electromagnetic radiation. The step of illuminating the scene with substantially circularly polarised electromagnetic radiation enables objects of interest to be distinguished within the scene with maximum contrast to their natural surroundings.

The invention will now be described, by example only, with reference to the accompanying drawings in which;

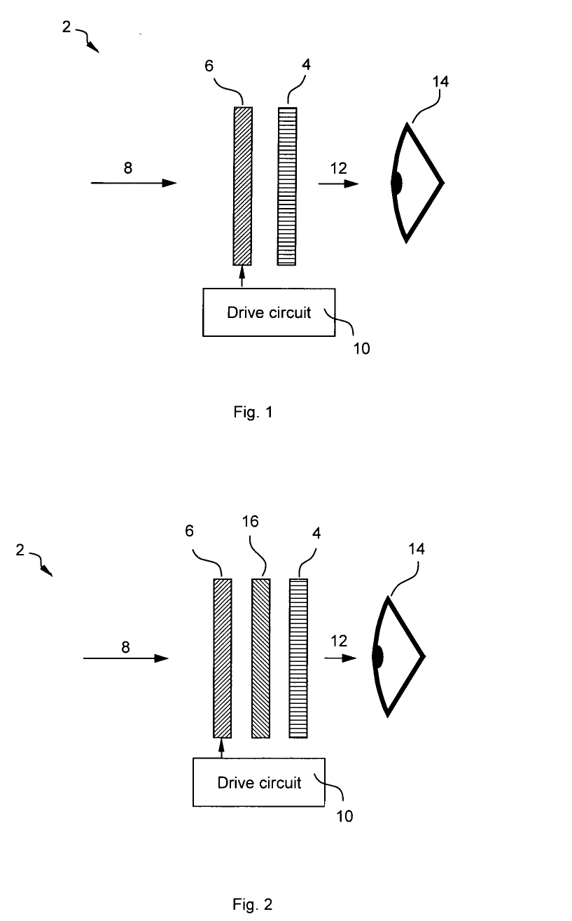

FIG. 1 shows a schematic view of a polarimetric imaging apparatus according to one embodiment of the present invention.

FIG. 2 shows a schematic view of a polarimetric imaging apparatus according to a second embodiment of the present invention.

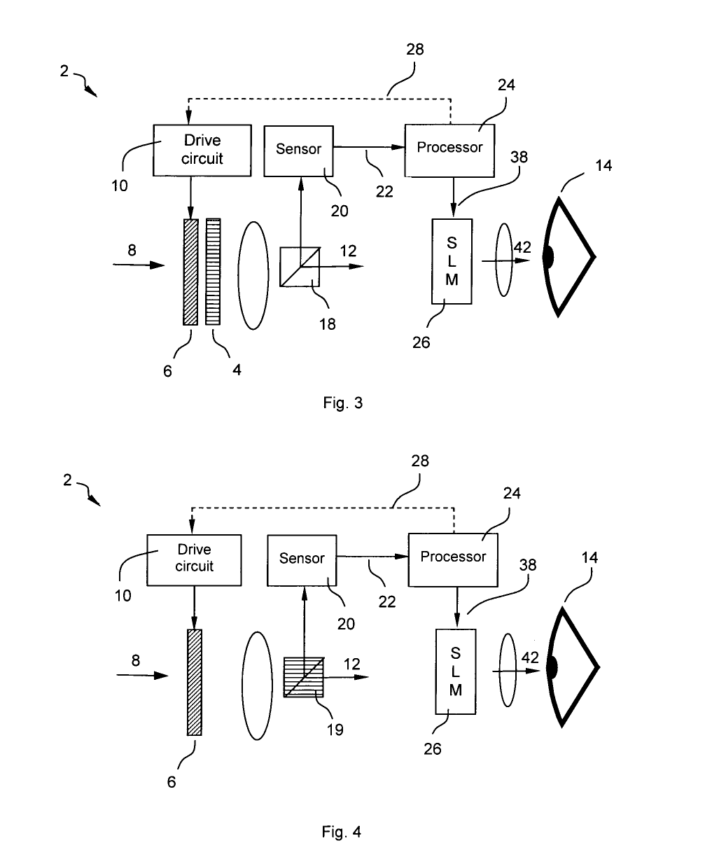

FIG. 3 shows a schematic view of a polarimetric imaging apparatus according to a further embodiment of the present invention. In this embodiment, the images produced by the resolving means are monitored using a sensor and a comparison thereof made using a processor. Objects of interest within the scene are displayed on a spatial light modulator (SLM) superimposed on the output from the circular analyser.

FIG. 4 shows a schematic view of a polarimetric imaging apparatus according to another embodiment of the present invention in which the linear polariser is replaced by a polarising beam splitter.

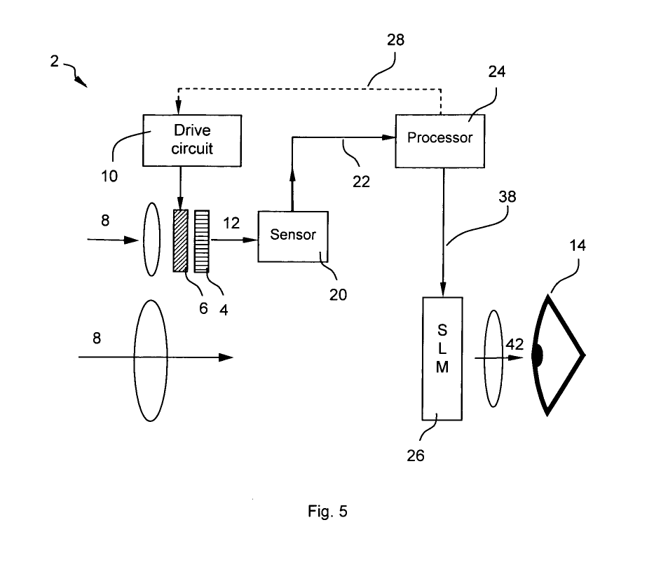

FIG. 5 shows a schematic view of a polarimetric imaging apparatus according to another embodiment of the present invention in which objects of interest within the scene are displayed on a spatial light modulator (SLM) superimposed on a direct view of the scene.

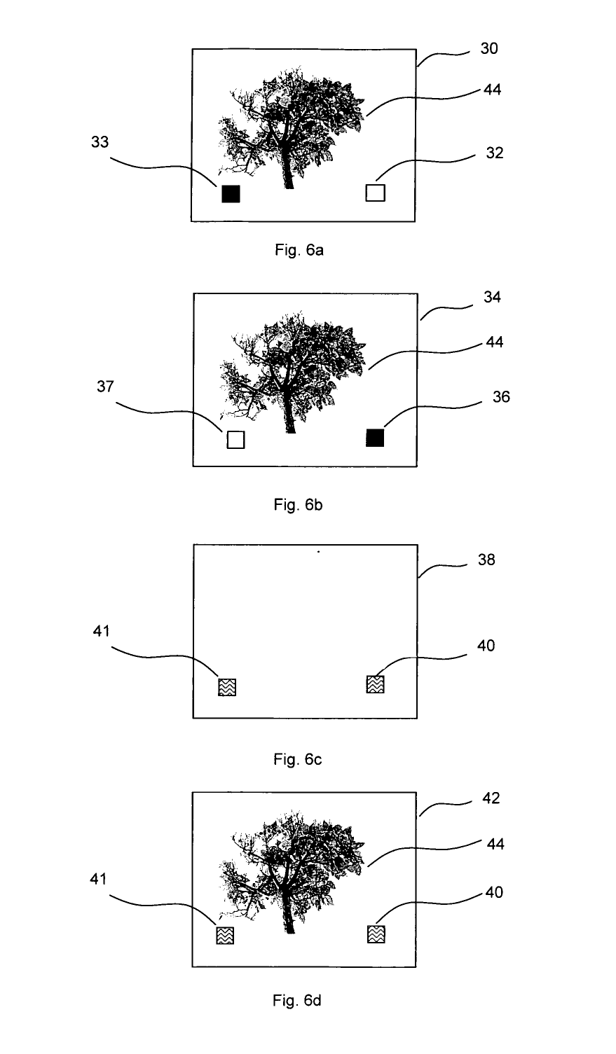

FIGS. 6a-6d illustrate simulated images from the polarimetric imaging apparatus of FIGS. 1-4. Specifically, FIGS. 6a-6b show sequential images from the polarimetric imaging apparatus of FIGS. 1-5 indicating the manner in which an object within a scene reflecting light having a substantially circular polarisation state is distinguished. FIG. 6c shows a simulated SLM image from the polarimetric imaging apparatus of FIG. 5 in which an object within a scene reflecting light having a substantially circular polarisation state is highlighted. FIG. 6d shows a simulated composite output from the polarimetric imaging apparatus of FIG. 5 in which the object within the scene reflecting light having a substantially circular polarisation state is highlighted with respect to its position within the scene.

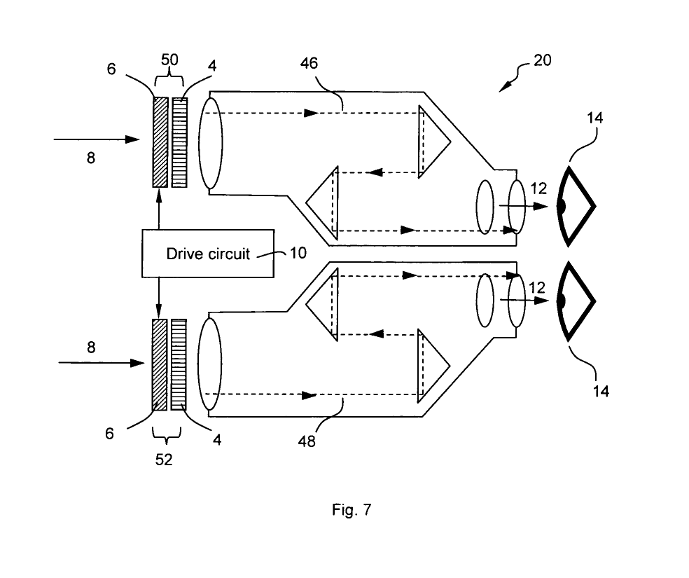

FIG. 7 shows a schematic plan view of a pair of polarimetric binoculars according to another embodiment of the present invention incorporating a plurality of polarimetric imaging apparatuses of FIG. 1.

The present polarimetric imaging apparatus detects left and right circularly polarised components by sequentially converting left and right circular polarised electromagnetic radiation received from the scene into linearly polarised electromagnetic radiation. The linearly polarised electromagnetic radiation is detected by filtering using a linear polariser.

Referring now to the drawings wherein like reference numerals identify corresponding or similar elements throughout the several views, FIG. 1 shows a schematic view of a polarimetric imaging apparatus according to a first embodiment of the present invention.

In the first embodiment of the invention, the polarimetric imaging apparatus 2 comprises an optical analyser for detecting left and right circular polarised electromagnetic radiation received from the scene. The optical analyser comprises a linear polariser 4 arranged in optical communication with a variable optical retarder 6 configured to receive electromagnetic radiation 8 from the scene.

Electromagnetic radiation 8 entering the polarimetric imaging apparatus 2 first passes through the variable retarder 6 which is repeatedly switched between two configurations by a drive circuit 10 so as to modulate the incoming electromagnetic radiation 8 between two states. Without limitation, the variable retarder 6 comprises a liquid crystal variable retarder. In the first configuration, the liquid crystal variable retarder 6 is arranged to provide a retardance of 90 degrees (i.e. the liquid crystal variable retarder 6 is configured as a quarter-wave plate), which results in left circular polarised electromagnetic radiation being converted to linearly polarised electromagnetic radiation having a first linear polarisation state. In the second configuration, the liquid crystal variable retarder 6 is arranged to provide a retardance of 270 degrees (i.e. the liquid crystal variable retarder 6 is configured as a three-quarter-wave plate), which results in left circular polarised electromagnetic radiation being converted to linearly polarised electromagnetic radiation having a linear polarisation state orthogonal to the first linear polarisation state.

Electromagnetic radiation having the first linear polarisation state is detected by selectively filtering the output from the liquid crystal variable retarder 6 using the linear polariser 4. This is achieved by orientating the transmission axis of the linear polariser 4 with respect to the liquid crystal variable retarder 6 such that electromagnetic radiation having the first linear polarisation state passes unhindered through the first linear polariser 4.

The intensity of electromagnetic radiation emerging from the polariser 4 is reduced as a function of the cosine of the angle between the azimuth of the electromagnetic radiation and the orientation of the transmission axis of the polariser 4 (according to Malus' Law; where lₒᵤₜ=lᵢₙ cos² θ). Accordingly, the linear polariser 4 progressively attenuates linearly polarised electromagnetic radiation emanating from the liquid crystal variable retarder 6 as the angle between the azimuth of the linearly polarised electromagnetic radiation and the orientation of the transmission axis of the polariser 4 increases.

Hence, the linear polariser 4 transmits electromagnetic radiation having the first linear polarisation state, but will substantially block electromagnetic radiation having a linear polarisation state orthogonal to the first linear polarisation state. Note that the linear polariser will also transmit a proportion of any randomly polarised, elliptically polarised and circularly polarised electromagnetic radiation emanating from the first optical retarder 6.

Electromagnetic radiation 12 passing through the linear polariser 4 is detected by an eye 14 of an observer. Alternatively, a sensor (not shown in FIG. 1) detects the electromagnetic radiation 12. Optionally the sensor comprises a camera capable of recording a spatial image of the scene. The sensor may comprise any device capable of detecting radiation from within the electromagnetic spectrum, for example a focal plane array, a CCD array, a CMOS array, an infrared imager, and a thermal imager.

Switching the liquid crystal variable retarder 6 between the two configurations therefore allows the linear polariser 4 to alternately block and transmit the linearly polarised electromagnetic radiation corresponding with the left circular polarised electromagnetic radiation received from the scene.

Hence, electromagnetic radiation 12 passing through the linear polariser 4 consists of a spatial image of the scene in which objects of interest there-within having substantially left circular polarised electromagnetic radiation emanating there-from will appear to scintillate or flash in sympathy with the modulation frequency of the liquid crystal variable retarder 6. Modulating the intensity of spatial regions of the image with respect to time in this manner enables objects of interest corresponding with said spatial regions to be distinguished easily within the scene since such modulation is particularly conspicuous to the eye.

It will be evident to the skilled person that right circular polarised electromagnetic radiation received from the scene is also modulated by the present polarimetric imaging apparatus. However, said right circular polarised electromagnetic radiation is blocked and transmitted by the linear polariser 4 out of phase with the left circular polarised electromagnetic radiation.

Thus, in the first configuration, the liquid crystal variable retarder 6 converts right circular polarised electromagnetic radiation to linearly polarised electromagnetic radiation having a linear polarisation state orthogonal to the first linear polarisation state. In the second configuration, the liquid crystal variable retarder 6 converts the right circular polarised electromagnetic radiation to linearly polarised electromagnetic radiation having the first linear polarisation state.

Hence, electromagnetic radiation 12 passing through the linear polariser 4 consists of a spatial image of the scene in which objects of interest there-within having substantially right circular polarised electromagnetic radiation emanating there-from will appear to scintillate or flash in sympathy with the modulation frequency of the liquid crystal variable retarder 6.

If the scene contains objects having left circular polarised electromagnetic radiation emanating there-from and objects having right circular polarised electromagnetic radiation emanating there-from, said objects of interest will appear to scintillate or flash alternately within the spatial image of the scene.

Referring now to FIG. 2, in a second embodiment of the present polarimetric imaging apparatus the liquid crystal variable retarder 6 is arranged in optical communication with a fixed retarder 16 having a 90 degree retardance (quarter-wave plate). In this embodiment, the incoming electromagnetic radiation 8 received from the scene first passes through the liquid crystal variable retarder 6 and then through the fixed retarder 16. Alternatively, the liquid crystal variable retarder 6 and the fixed retarder 16 are transposed in which case the incoming electromagnetic radiation 8 received from the scene first passes through the fixed retarder 16 and then through the liquid crystal variable retarder 6. The principle of operation of the polarimetric imager is the same as in the first embodiment of FIG. 1, however, the required retardances of the two states are achieved by passing through two waveplates 6, 16 rather than just the single liquid crystal variable retarder 6 (the effect of the two waveplates 6, 16 being additive). This configuration is beneficial in that the liquid crystal variable retarder need only exhibit a maximum retardance of 180 degrees rather than the 270 degrees retardance required in the embodiment of FIG. 1. For the avoidance of doubt, the retardance range of the variable liquid crystal retarder is 180 irrespective of whether a fixed retarder is employed or not.

In the foregoing embodiments, the variable retarder 6 is assumed to be substantially achromatic, i.e. the variable retarder 6 retards circularly polarised electromagnetic radiation having a plurality of different wavelengths by substantially the same angle; all wavelengths being converted to a substantially linear polarisation state so as to be blocked or transmitted unhindered by the linear polariser 4.

Optionally, the variable retarder 6 comprises a chromatic variable retarder. In use, the chromatic variable retarder imparts a false hue to objects of interest within the scene since the amount of retardation created by the chromatic variable retarder varies as a function of the wavelength of the received electromagnetic radiation. In this case only one wavelength is converted to a substantially linear polarisation state and blocked or transmitted unhindered by the linear polariser; electromagnetic radiation comprising the other wavelengths being converted to an elliptical state and partially blocked or transmitted by the linear polariser.

This effect enables objects of interest to be readily distinguished within a spatial image of the scene. Varying both the hue and intensity of objects of interest ensures said objects are optimally conspicuous to the eye since human peripheral vision is particularly sensitive to intensity variations (flashing) whereas human direct vision is particularly sensitive to variations in hue (colouration).

Referring now to FIG. 3, which illustrates a third embodiment of the present polarimetric imaging apparatus, objects of interest distinguished within the scene are highlighted on an alternative form of display. In this embodiment objects of interest are distinguished by varying the hue, saturation or intensity of spatial regions of an image of the scene corresponding with said objects of interest. For example, objects of interest are highlighted within the image by making said objects appear light, dark, and/or coloured within the image.

In the embodiment shown in FIG. 3, the circular analyser operates as in the foregoing embodiments. However, in this embodiment the polarimetric imaging apparatus includes a beamsplitter 18 disposed in the optical train of the imager after the linear polariser 4. The beamsplitter 18 is arranged in use to intercept electromagnetic radiation emanating from the linear polariser 4 and to divide a portion of said electromagnetic radiation to a sensor 20.

Electromagnetic radiation passing through the linear polariser 4 is detected by the sensor 20 which provides an output 22 corresponding thereto to a processor 24 for further analysis. Without limitation, the sensor 20 comprises a camera capable of recording a spatial image of the scene. The sensor 20 may comprise any device capable of detecting radiation from the electromagnetic spectrum, for example a focal plane array, a CCD array, a CMOS array, an infrared imager, and a thermal imager.

In use, the output 22 from the sensor 20 is monitored by the processor 24 to determine spatial regions of the scene having an intensity which modulates as the liquid crystal variable retarder 6 is switched repeatedly between the first and second configurations.

By way of explanation of the comparison process (FIGS. 3 and 6 refer), when the liquid crystal variable retarder 6 is arranged in the first configuration, sensor 20 provides a first output 22 comprising a first spatial image 30 of the scene in which objects having left circular polarised electromagnetic radiation emanating there-from are shown having a high image intensity and in which objects having right circular polarised electromagnetic radiation emanating there-from are shown having a low image intensity.

Conversely, when the liquid crystal variable retarder 6 is arranged in the second configuration sensor 20 provides a second output 22 comprising a second spatial image 34 of the scene in which objects having right circular polarised electromagnetic radiation emanating there-from are shown having a high image intensity and in which objects having left circular polarised electromagnetic radiation emanating there-from are shown having a low image intensity.

The spatial images 30, 34 are compared by the processor by determining differences in image intensity between the two images 30, 34 to identify spatial regions there-within corresponding with objects of interest in the scene. For example, each spatial image 30, 34 typically comprises a plurality of picture elements or “pixels” and the differences in image intensity is determined by performing a pixel-wise comparison of identical spatial regions of the two images 30, 34.

A resultant image 38 is output by the processor 24 to a spatial light modulator 26 which highlights the areas 40, 41 within the scene corresponding with objects of interest therein having circularly polarised electromagnetic radiation emanating there-from. To reiterate, objects of interest are distinguished in the image 38 by varying the hue, saturation or intensity of spatial regions of the image 38 corresponding with said objects of interest. For example, objects of interest are highlighted within the image 38 by making said objects appear light, dark, and/or coloured within the image 38.

The spatial light modulator 26 superimposes the image 38 on the observer's view of the scene to provide a composite image 42 to the observer's eye 14. Thus, the observer is presented with the image 42 of the scene with the addition of the polarimetric information from the scene superimposed in an appropriate format due to the spatial light modulator 26.

By way of further explanation, natural objects 44 will appear in the same spatial regions of both images 30, 34 and with substantially the same image intensity. In contrast, manmade objects of interest within the scene will appear in the same spatial regions of both images 30, 34 but with different image intensities due to the predominant left or right circular polarised electromagnetic radiation emanating there-from.

For example, referring to FIG. 6a, a manmade object of interest within the scene giving rise to electromagnetic radiation having a predominant left circular polarised component will appear in the first image 30 as a spatial region 32 of high image intensity, i.e. such object will appear bright within the image 30. Referring now to FIG. 6b by way of comparison, the same object will appear in the second image 34 as a spatial region 36 of low image intensity, i.e. such object will appear dark within the image 34. As mentioned above, natural objects 44 will appear in the same spatial regions of both images 30, 34 and with substantially the same image intensity.

Similarly, a manmade object of interest within the scene giving rise to electromagnetic radiation having a predominant right circular polarised component will appear in the first image 30 as a spatial region of low image intensity 33, i.e. such object will appear dark within the image 30. Whereas, the same object will appear in the second image 34 as a spatial region of high image intensity 37, i.e. such object will appear bright within the image 34.

Referring to FIG. 6c, the comparison of the two images 30, 34 is performed by differencing said images, for example by subtracting absolute values of pixels in one image 30 from those of related pixels in the other image 34. Additional image processing is optionally performed after the differencing process to correct for any minor discrepancies in pixel intensity levels between the two images 30, 34, for example a thresholding procedure is optionally performed. An intermediate image 38 is thus created comprising spatial regions 40, 41 corresponding with regions of images 30, 34 having substantially different image intensity. Said spatial regions 40, 41 are indicative of the presence and location of objects of interest in the scene giving rise to circularly polarised electromagnetic radiation.

Referring now to FIG. 6d, objects of interest within the scene are distinguishing by varying at least one of the hue, saturation and intensity of spatial regions 40, 41 and superimposing the spatial regions 40, 41 highlighted in this manner onto the observer's view of the scene to provide output image 42 to the observer's eye 14. Alternatively, or in addition, objects of interest within the scene are distinguished by varying at least one of the hue, saturation and intensity of spatial regions 40, 41 and superimposing the spatial regions 40, 41 highlighted in this manner onto a composite image comprising the sum of the first and second images 30, 34. The output image 42 is viewed directly by an observer or is optionally recorded for subsequent analysis.

A feedback loop 28 is optionally included between the processor 24 and the liquid crystal variable retarder 6 to alter the drive voltages applied thereto by the drive circuit 10 to optimise the polarisation state being observed in order to achieve optimum performance.

FIG. 4 shows another embodiment of the polarimetric imaging apparatus in which a separate linear polariser 4 and beamsplitter 18 are replaced by a polarising beamsplitter 19. The mode of operation is identical to that for the embodiment of FIG. 3.

Referring now to FIG. 5, in another embodiment of the present polarimetric imaging apparatus, objects of interest within the scene are displayed on a spatial light modulator (SLM) superimposed on a direct view of the scene rather than on the output 12 from the circular analyser. The operation of the polarimetric imager in this embodiment is similar to that of the embodiment of FIGS. 3 and 4. The beamsplitter 18, 19 is dispensed with in this embodiment and the output 12 from the circular analyser passes only to the sensor 20.

The present polarimetric imaging apparatus is capable of imaging using electromagnetic radiation in a variety of wavebands. For example, without limitation the imaging apparatus is operable in the ultraviolet (UV), visible, near infrared (NIR), short-wave infrared (SWIR), medium-wave infrared (MWIR), and long-wave infrared wavebands.

The present polarimetric imaging apparatus is primarily a passive imager adapted to image a scene using naturally occurring ambient electromagnetic radiation reflected from objects within the scene. Optionally, the polarimetric imager comprises a source of electromagnetic radiation arranged to actively illuminate the scene with electromagnetic radiation. Active illumination of the scene is used to supplement the ambient electromagnetic radiation occurring naturally within the environment, or alternatively when there is insufficient ambient electromagnetic radiation occurring naturally within the environment within a given waveband of interest.

The polarimetric imaging apparatus of any of the foregoing embodiments may be used in conjunction with other optical apparatuses designed to enhance vision, for example without limitation in conjunction with lenses, zoom lenses, telescopes, binoculars, image intensifiers etc. By way of specific example, FIG. 7 shows a schematic plan view of a pair of polarimetric binoculars 20 according to another embodiment of the present invention incorporating a plurality of polarimetric imaging apparatuses of FIG. 1.

The binoculars 20 comprise a first polarimetric imaging apparatus 50 of the embodiment of FIG. 1 arranged in a first optical path 46 through the binoculars and a second polarimetric imaging apparatus 52 of the embodiment of FIG. 1 arranged in a second optical path 48 through the binoculars.

In this embodiment, the first and second polarimetric imaging apparatuses 50, 52 each have a fast axis associated therewith. Without limitation, the fast axis of the first polarimetric imaging apparatus 50 is orientated with respect to the fast axis of the second polarimetric imaging apparatus 52 at an angle other than substantially zero degrees, 45 degrees, and 90 degrees, i.e. the fast axes of the first and second imaging apparatuses 50, 52 are specifically arranged so as to be offset.

This configuration is beneficial in that it overcomes a potential performance limitation of the present polarimetric imaging apparatus.

By way of explanation, all conventional polarimetric imaging systems (i.e. linear polarimetric imaging systems) have a limiting case where a particular polarisation state is not detectable and the present polarimetric imaging apparatus is no exception.

Specifically, the present polarimetric imaging apparatus is optimally sensitive to substantially circularly polarised electromagnetic radiation, with decreasing sensitivity as the polarisation state becomes elliptical and approaches linear. Hence, although optimised to distinguish objects of interest within a scene having substantially circularly polarised electromagnetic radiation emanating there-from, the present polarimetric imaging apparatus is to a lesser extent also capable of distinguishing objects of interest within a scene having substantially elliptically or linearly polarised light emanating there-from. In common with the foregoing, any such objects will appear to scintillate or flash within the scene, although the effect is much less well pronounced than for circularly polarised electromagnetic radiation received from the scene. Accordingly, in practice, a spatial image of a scene may contain spatial regions in which the intensity modulates strongly (corresponding with objects having substantially circularly polarised light emanating there-from) and spatial regions in which the intensity modulates weakly (corresponding with objects having elliptically or linearly polarised light emanating there-from).

The skilled person will appreciate that elliptically polarised electromagnetic radiation received from the scene will be converted by the variable retarder 6 to electromagnetic radiation having a different elliptical polarisation state to that of the incoming state. Indeed, the incoming elliptically polarised electromagnetic radiation will be converted to electromagnetic radiation having two different elliptical polarisation states as the variable retarder 6 is repeatedly switched between the first and second configurations. The linear polariser 4 will partially block the elliptically polarised electromagnetic radiation emanating from the variable retarder 6. The amount of attenuation provided by the linear polariser 4 will be different for each of the two elliptical polarisation states output by the variable retarder 6 and hence the incoming elliptically polarised electromagnetic radiation will give rise to an output from the linear polariser 4 which will appear to scintillate or flash weakly in sympathy with the modulation frequency of the variable retarder 6.

Similarly, the skilled person will appreciate that linearly polarised electromagnetic radiation received from the scene will generally be converted by the variable retarder 6 to electromagnetic radiation having an elliptical polarisation state. Indeed, the incoming linearly polarised electromagnetic radiation will be converted to electromagnetic radiation having two different elliptical polarisation states as the variable retarder 6 is repeatedly switched between the first and second configurations. The linear polariser 4 will partially block the elliptically polarised electromagnetic radiation emanating from the variable retarder 6. The amount of attenuation provided by the linear polariser 4 will be different for each of the two elliptical polarisation states output by the variable retarder 6 and hence the incoming linearly polarised electromagnetic radiation will give rise to an output from the linear polariser 4 which will appear to scintillate or flash weakly in sympathy with the modulation frequency of the variable retarder 6.

However, there are three limiting cases where the current polarimetric imaging apparatus will not detect polarised light received from the scene, namely linearly polarised light oriented parallel to the fast axis (there is no slow axis component), linearly polarised light oriented parallel to the slow axis (there is no fast axis component) and linearly polarised light oriented along either of the two angles which bisect the fast and slow axes.

In summary, if the fast axes of the first and second polarimetric imaging apparatuses 50, 52 are parallel (in any orientation), incoming light which is linearly polarised either perpendicular or parallel to the fast axes will pass unhindered irrespective of the configuration of the variable retarder 6 and therefore won't modulate in intensity in the output 12.

Similarly, if the fast axes of the first and second polarimetric imaging apparatuses 50, 52 are parallel (in any orientation), incoming light which is oriented along either of the two angles which bisect the fast and slow axes (i.e. linearly polarised light orientated at 45 or 135 degrees to the fast axes) has equal fast and slow axis components and said linearly polarised light is converted to purely circularly polarised light in both optical paths (alternating between left and right for each as the variable retarders 6 are switched between first and second configurations). Hence, the circularly polarised light is treated equally by the polarisers 4 in the first and second polarimetric imaging apparatuses 50, 52 in both configurations of the variable retarder 6 and hence will not give rise to an observable effect.

By offsetting the fast axes of the first and second polarimetric imaging apparatuses 50, 52, when these limiting cases are reached for one optical path, they are not reached for the other and vice versa.

In the embodiment of FIG. 7, the abovementioned limiting conditions can be overcome because the polarimetric binoculars have two optical paths there through. This is achieved by avoiding the situation where the limiting cases mentioned above affect both optical trains concurrently. By deliberately breaking the symmetry between the two optical paths (offsetting the fast axes of the first and second imaging apparatuses 50, 52), said two optical paths will experience unequal intensity variations in the rare occasion where the limiting case would otherwise have been reached.

The sensitivity of the polarimetric binoculars to circularly polarised light is unaffected by the asymmetrical arrangement of the two optical paths; the frequency and magnitude of the observed intensity fluctuations will be the same for both optical paths for circularly, or substantially circularly polarised light.

Hence, by arranging the two paths so that they are at an angle relative to each other which is not 0°, 45° or 90° the present polarimetric binoculars successfully avoid the limiting cases.

Without limitation, for optimum effect the fast axis of the first polarimetric imaging apparatus 50 is orientated at an angle of substantially 22.5° or 67.5° with respect to the fast axis of the second polarimetric imaging apparatus 52.

Although not shown in the figure, the fast axis of the first 50 polarimetric imaging apparatus or the second polarimetric imaging apparatus 52 is arranged at an angle of substantially 22.5 degrees to a plane passing through the first and second optical paths. Typically, the fast axis of the first 50 polarimetric imaging apparatus or the second polarimetric imaging apparatus 52 shall be arranged in use at an angle of substantially 22.5 degrees to a horizontal plane.

By way of further explanation, the orientation of the first and second polarimetric imaging apparatuses is unimportant when viewing fully circularly polarised light, since a circle is the same in any orientation. However, even though the present polarimetric binoculars are optimised to detect circularly polarised light, it is useful to be able to detect linearly polarised light as well. Typically, most of the linearly polarised light received from a scene is likely to be substantially horizontally polarised (particularly in the visible band viewed from a typical perspective), for example such as light reflected from a road surface. Accordingly the fast axis of either the first or the second polarimetric imaging apparatus 50, 52 is arranged in use at an angle of substantially 22.5 degrees to the horizontal plane so as to be optimally sensitive to substantially horizontally linearly polarised light.

In view of the foregoing description it will be evident to a person skilled in the art that various modifications may be made within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived there-from. In particular, with reference to the appended claims, features from dependent claims may be combined with those of the independent claims and features from respective independent claims may be combined in any appropriate manner and not merely in the specific combinations enumerated in the claims.

1. A polarimetric imaging apparatus for distinguishing objects of interest within a scene, said apparatus comprising a circular analyser for resolving electromagnetic radiation received from the scene having a first substantially circular polarisation state into a first image and for resolving electromagnetic radiation received from the scene having a second substantially circular polarisation state of opposite handedness to that of the first circular polarisation state into a second image, and a display for providing an output indicative of the difference there-between, wherein the circular analyser is arranged in use to resolve said electromagnetic radiation into said first and second images successively.

2. (canceled)

3. A polarimetric imaging apparatus according to claim 1 adapted in use to passively distinguish objects of interest within the scene using ambient electromagnetic radiation received there-from.

4. (canceled)

5. A polarimetric imaging apparatus according to claim 1 wherein the circular analyser comprises a linear polariser arranged in optical communication with a variable retarder configured to receive electromagnetic radiation from the scene.

6. A polarimetric imaging apparatus according to claim 5 wherein the variable retarder is adapted in a first configuration to convert electromagnetic radiation having the first substantially circular polarisation state to electromagnetic radiation having a first linear polarisation state parallel to a transmission axis of the linear polariser, and is adapted in a second configuration to convert electromagnetic radiation having the second substantially circular polarisation state to electromagnetic radiation having the first linear polarisation state.

7. A polarimetric imaging apparatus according to claim 6 wherein the variable retarder is arranged in the first configuration to have a retardance of substantially 90 degrees and is arranged in the second configuration to have a retardance of substantially 270 degrees.

8. (canceled)

9. (canceled)

10. (canceled)

11. A polarimetric imaging apparatus according to claim 5 wherein the variable retarder comprises a liquid crystal variable retarder in optical communication with a fixed retarder.

12. A polarimetric imaging apparatus according to claim 5 wherein the variable retarder comprises a chromatic variable retarder.

13. A polarimetric imaging apparatus according to claim 1 further comprising a sensor arranged to sense the first and second images transmitted through the circular analyser and a processor adapted in use to determine the difference between successive outputs from the sensor to provide said output indicative of the difference between the first and second images, wherein the successive outputs from the sensor and the output indicative of the difference between the first and second images comprise spatial images of at least part of the scene and the processor is adapted in use to determine differences in image intensity between said successive outputs of the sensor and to denote objects of interest within the scene corresponding with said intensity differences.

14. (canceled)

15. (canceled)

16. (canceled)

17. (canceled)

18. (canceled)

19. (canceled)

20. A polarimetric imaging apparatus according to claim 1 further comprising a polarising beam splitter arranged in optical communication with the circular analyser and wherein the linear polariser is comprised of said polarising beam splitter.

21. (canceled)

22. A polarimetric imaging apparatus according to claim 1 wherein, in use, objects of interest are distinguished within an image of the scene by varying at least one of hue, saturation and intensity of spatial regions within said image corresponding with said objects of interest.

23. (canceled)

24. (canceled)

25. Binoculars comprising at least one polarimetric imaging apparatus according to claim 1 arranged in an optical path of said binoculars.

26. Binoculars according to claim 25 having first and second optical paths there through, said binoculars comprising a first and second polarimetric imaging apparatus arranged in the first and second optical paths thereof.

27. Binoculars according to claim 26, the first and second polarimetric imaging apparatuses each having a fast axis associated therewith, wherein the fast axis of the first polarimetric imaging apparatus is orientated with respect to the fast axis of the second polarimetric imaging apparatus at an angle other than substantially zero degrees, 45 degrees, and 90 degrees.

28. Binoculars according to claim 27, wherein the fast axis of the first polarimetric imaging apparatus is orientated at an angle of one of substantially 22.5 and 67.5 degrees to the fast axis of the second polarimetric imaging apparatus.

29. Binoculars according to claim 27 wherein the fast axis of one of the first and second polarimetric imaging apparatuses is arranged at an angle of substantially 22.5 degrees to a plane passing through the first and second optical paths.

30. A method of distinguishing objects of interest within a scene comprising the steps of:
(i) receiving electromagnetic radiation from the scene,
(ii) resolving electromagnetic radiation received from the scene having a first substantially circular polarisation state into a first image,
(iii) resolving electromagnetic radiation received from the scene having a substantially circular polarisation state of opposite handedness to that of the first circular polarisation state into a second image,
(iv) comparing the first and second images so as to identify differences there-between
(v) providing an output indicative of the difference between the first and second images,
wherein the steps of resolving the electromagnetic radiation received from the scene into said first and second images are performed successively.

31. (canceled)

32. A method according to claim 30 comprising passively distinguishing objects of interest within the scene using ambient electromagnetic radiation received there-from.

33. A method according to claim 30 wherein the step of resolving the electromagnetic radiation received from the scene having a first substantially circular polarisation state comprises converting said first substantially circular polarisation state into the first image consisting of electromagnetic radiation having a first linear polarisation state, and the step of resolving the electromagnetic radiation received from the scene having a second substantially circular polarisation state comprises converting said second substantially circular polarisation state into the second image consisting of electromagnetic radiation having the first linear polarisation state.

34. (canceled)

35. A method according to claim 30 wherein the first and second images and the output indicative of differences there-between comprise spatial images of at least part of the scene and the step of comparing the first and second images comprises determining differences in image intensity there-between and denoting objects of interest within the scene corresponding with said intensity differences.

36. A method according to claim 35 comprising the step of distinguishing objects of interest within the scene by varying at least one of hue, saturation and intensity of spatial regions within said output corresponding with said objects of interest.

37. (canceled)

38. (canceled)
